(19) United States
(12) Patent Application Publication
(10) Pub. No.: US 2003/0180435 A1
(43) Pub. Date: Sep. 25, 2003

(54) Separation of carotenoids from fruits and vegetables

(76) Inventor: John Shi, Guelph (CA)

Correspondence Address: DINSMORE & SHOHL, LLP, 1900 CHEMED CENTER, 255 EAST FIFTH STREET, CINCINNATI, OH, 45202, US

(21) Appl. No.: 10/240,583

(22) PCT Filed: Apr. 6, 2001
(86) PCT No.: PCT/CA01/00478

(30) Foreign Application Priority Data
Apr. 12, 2000 (CA) 2,305,091

(51) Int. Cl. A23K 1/00

(52) U.S. Cl. 426/615

(57) ABSTRACT

A method for the separation of carotenoids, especially lycopene, from fruits and vegetables, especially tomatoes. A mixture of powdered fruit and/or vegetable and an edible oil is subjected to supercritical —CO₂ fluid extraction. A mixture of the oil and lycopene is separated. Lycopene of food grade quality is obtained.

The present invention relates to the separation of carotenoids from fruits and vegetables. In particular, the present invention relates to a method for the separation of lycopene from tomatoes, lycopene being the principal carotenoid in tomatoes. The method involves supercritical carbon dioxide (CO₂) fluid extraction (SFE—CO₂) of a mixture of edible oil and fruits and vegetables, and especially to the extraction of a mixture of edible oil and powdered fruits and vegetables.

Tomatoes are an important agricultural commodity. In some end-uses, the whole tomato is used, for example domestic or restaurant uses of various forms of sliced or diced tomatoes. In other end-uses, tomatoes are processed into another product e.g. to form canned tomatoes or ketchup. Many of the latter uses involve removal of the tomato skin from the pulp.

More than 21 pigments in the carotenoid class have been identified and quantified in the fruit of tomatoes. Lycopene is the principal carotenoid in tomatoes, typically being in amounts of 85-90% by weight of the carotenoids. Low amounts of other carotenoids e.g. α-carotene, β-carotene, Υ-carotene, ξ-carotene, phytoene, phytofluene, neurosporene and lutein are also present in tomatoes.

There has been a growing interest in research into the properties of lycopene, and especially the ability of lycopene to act as a cancer preventative agent. Lycopene is able to function as an antioxidant and it exhibits a physical quenching rate constant with singlet oxygen in vitro. The quenching constant of lycopene was found to be more than double that of β-carotene and 10 times more than that of α-tocopherol. Consequently, the potential for and benefits of use of lycopene in a diet is of considerable interest. Increasingly, clinical evidence is being obtained in support of the role of lycopene as an important micronutrient, as it appears to provide protection against a broad range of epithelial cancers. Consumers, researchers and the food industry have dramatically increased their interest in and awareness of the potential health benefits of lycopene obtained from tomatoes. Industrial production of lycopene from tomatoes and other fruits and vegetables is sought by food, nutraceutical and pharmaceutical companies.

Lycopene that has been extracted from fresh fruits and vegetables, including tomatoes, or from products of fruits and vegetables has been studied extensively using high pressure liquid chromatography (HPLC) analysis. The usual method of extraction utilizes organic solvents such as chloroform, hexane, acetone, benzene, or carbon disulphide.

Commercially pure lycopene e.g. for use as a standard for chemical analysis, is available from Sigma Co. and is understood to be obtained by extraction using a chemical solvent. Such a process is described in U.S. Pat. No. 5,837,311.

The solubility of lycopene under SFE conditions is low, which is due to its high molecular weight (536.85 Daltons). Thus, the yield of lycopene by such extraction would also be expected to be low.

A lycopene extraction and purification procedure that is capable of being used on an industrial scale and which utilizes an environmentally friendly and chemical-fee procedure, with minimal loss of bioactivity, would be of substantial potential benefit in the food, feed, cosmetic and pharmaceutical industries. High quality lycopene will offer potential benefits to the food industry. A successful commercialization of high-value lycopene production may also improve the competitiveness of nutraceutical products in the global market, and may lead to the use of lycopene in other end-uses.

A method has now been found for the extraction of carotenoids, especially lycopene, in high yields from fruits and vegetables, including tomatoes, such method not involving use of organic solvents that are potentially hazardous to health.

Accordingly, one aspect of the present invention provides a method for the separation of carotenoids from fruits and vegetables, comprising the steps of:

(a) admixing a powder of at least one of said fruits and vegetables with an edible oil;

(b) subjecting the mixture of said powdered fruits and vegetables and edible oil to supercritical —CO₂ fluid extraction; and

(c) separating a mixture comprising said edible oil and carotenoids.

In a preferred embodiment of the present invention, the fruit and vegetable is tomato.

In a particularly preferred embodiment of the method of the present invention, the mixture separated in step (c) is a mixture comprising the edible oil and lycopene.

The present invention is illustrated by embodiment shown in the drawing, in which:

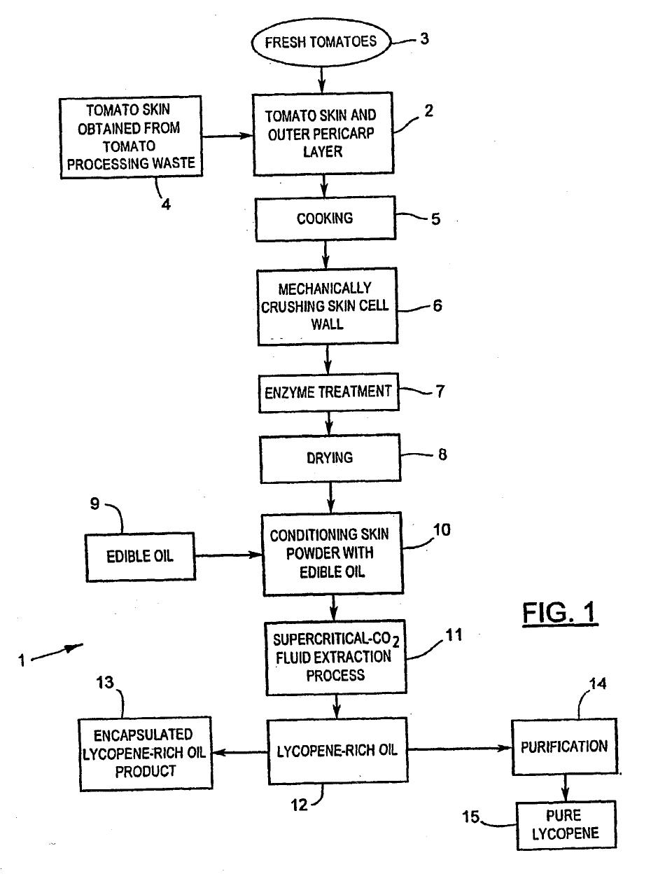

FIG. 1 is a schematic representation of a flow diagram of the method of the invention.

The present invention is directed to the extraction of carotenoids from fruit and vegetable containing the carotenoids. A variety of fruits and vegetables may be used, including mixtures of fruits and/or of vegetables, and a variety of carotenoids may be extracted. A preferred fruit or vegetable is tomato.

Lycopene is the principal carotenoid in tomatoes, and the method of the present invention will be described herein with particular reference to extraction of lycopene from tomatoes.

The tomatoes used in the method of the invention may be obtained from a variety of sources. Ripe tomatoes are preferred. Un-ripe tomatoes and tomatoes that have matured during storage all tend to contain lower amounts of lycopene, and are less preferred for use in the method of the present invention.

The tomatoes may be primarily in the form of tomato skins, as the skin and pericarp layers of the tomato contain approximately 80% of the total amount of lycopene in a ripe tomato. Nonetheless, whole tomatoes and mixtures of tomato skins and tomato pulp may be used. Use of tomato skins, or a composition containing a high percentage of tomato skins is preferred.

Prior to being subjected to the method of the invention, the tomatoes need to be converted to a particulate form, referred to herein as a powder form, especially a powder having low moisture content. A moisture content of less than 10% is preferred, especially a moisture content in the range of 6-9% by weight. Higher water contents tend to have adverse effects on absorption of lycopene into the oil, as described herein, and of lycopene dissolution in the mixture of oil and tomatoes. Thus, use of relatively low water contents is believed to be more effective in extraction of lycopene into the oil.

In order to prepare tomatoes for treatment in the method of the invention, and to facilitate extraction of lycopene, it is believed to be important to rupture the cell walls of the tomato. A variety of methods of rupturing the cell walls may be used. Thus, for example, in embodiments of forming the tomato powder, the tomatoes are subjected to at least one of mechanical crushing, freezing and thawing, cooking, homogenizing and freezing/dehydration i.e. freeze drying. The tomatoes may be mechanically crushed by any convenient method, including blending the tomatoes into a puree using a high speed homogenizer or bead mill. The tomato puree may be cooked in water or steam. The tomatoes may also be subjected to freeze drying.

It is preferred that the tomatoes be subjected to more than one of the above steps, to effect a substantial amount of breakdown of cell walls to permit extraction or release of lycopene. As noted above, it is understood that the greater the degree of breakdown of cell walls, the higher the potential yield of lycopene.

In embodiments of the invention, the tomatoes are subjected to a number of steps to form the powder, prior to being subjected to the method of the invention. For instance, the tomato skin and pericarp layers may be separated from the pulp of the tomato, which may be accomplished by for example treatment with steam or with lye i.e. sodium hydroxide or potassium hydroxide. The tomato skin and pericarp layers are collected and then mechanically crushed and homogenized into a puree. The puree is treated with an enzyme e.g. cellulase at levels of 200-300 International units (I.U.)/g of solid. This treatment may be carried out at ambient temperature. The puree is then cooked, for example at 60-95° C. for 10-40 minutes, and then freeze dried. The resultant powder is screened e.g. through a screen having a mesh size of 0.004-0.5 mm.

It is to be understood that the number and type or nature of steps in the treatment of the tomatoes, especially tomato skin and pericarp, and the order, may be varied. As noted above, yield of lycopene will tend to improve with increasing breakdown of the cell walls of the tomatoes.

After pretreatment, tomato material may be used immediately but if stored should be stored in the dark in a cooled and sealed container. For example, the tomato material may be stored in a closed (sealed) container in the dark at −18° C..

As noted above, the tomato powder should have a low water content, especially below 10% by weight. In the method of the invention, the tomato powder, especially tomato powder with a low moisture content, is mixed with an edible oil. A variety of edible oils may be used, including vegetable and fish oils. For example, the edible oil may be soybean salad oil, canola oil, corn germ oil, olive oil, fish oil or peanut oil. The amount of oil should be 520% by weight of the tomato powder. In particular, the ratio of tomato powder to edible oils should be in the range of 95:5 to 80:20, by weight. The mixture of tomatoes and oil is preferably maintained for a period of time e.g. overnight, at ambient temperature in a sealed container that excludes both oxygen and light, prior to extraction.

The mixture of tomato powder and edible oil is fed to a supercritical —CO₂ fluid extraction process, also known as SFE—CO₂. Such processes are known. The process operates at temperatures above ambient temperature e.g. at about 45-80° C., and under high pressure e.g. about 350-380 bar. The period of extraction is typically 120-180 min, and recovery of lycopene is typically greater than 55% by weight. The optimum processing parameters e.g. of temperature, time, pressure and oil content, are related to the variety of the tomato and to the quality of the skin powder. The high selectivity of the SFE—CO₂ process under optimum conditions provides a high concentration of lycopene in oil.

The method of the present invention is further illustrated by the embodiment shown in FIG. 1. In the method, generally indicated by 1, tomato skin and outer pericarp layer 2 are obtained from one or both of fresh tomatoes 3 and fresh tomato skin obtained from the waste of a tomato processing operation 4. Tomato skin and outer pericarp layer 2 are then cooked, 5, and subjected to mechanical crushing of the cell wall of the tomato skin, 6. The resultant puree is subjected to enzyme treatment, 7, as described herein, and then dried, 8. The skin powder thus obtained is then conditioned with edible oil 9 to provide conditioned skin powder in the edible oil 10. The resultant mixture is subjected to supercritical CO₂ fluid extraction 11 to provide lycopene-rich oil 12. The lycopene-rich oil 12 may be encapsulated to provide a product for sale 13. Alternatively, the lycopene-rich oil 12 may be subjected to purification steps 14 and sold as pure lycopene 15.

In fresh tomatoes, lycopene is an all trans-isomer structure. It is understood to be generally accepted that the all-trans form of lycopene has the highest stability but that the cis-isomers are more bioactive and easier to absorb by human body (high bioavailablity). However, cis-isomers are believed to be stable in the oil medium, and HPLC analysis of extracted lycopene typically shows that the lycopene obtained consists of about 55% trans-isomer and 45% cis-isomer. Thus, the method of the invention is useful to develop a cis-rich lycopene oil medium. The method is also used to develop cis-rich lycopene oil products after trans-isomer lycopene is converted into the cis-form during special pretreatment e.g. by heating the mixture or mechanical blending. Thus, the oil also acts as lycopene stabilizing agent.

Lycopene is believed to be substantially stable at ambient temperatures, e.g. room temperatures. The product obtained in the method of the invention is dark red in colour, is odourless and is may be used in the form obtained. For example, the mixture of oil and lycopene could be encapsulated for use e.g. as a potential anti-cancer functional food, or for other uses, using existing encapsulating facilities in food and pharmaceutical companies.

The SFE—CO₂ process is more environmentally friendly than other processes, especially in that chemical solvents are not used. Thus, steps to remove chemical solvents prior to use of the lycopene in food are not required.

The method of the present invention uses a material viz. tomato skins that is generally regarded as a waste material. It provides a product that is useful e.g. in encapsulated or other forms, and has substantial potential as a food supplement and potential as an anti-cancer agent.

The present invention is illustrated by the following example:

### EXAMPLE 1

The skin of tomatoes was separated from the fruit part of the tomatoes by steam peeling. The tomato skin, including the pericarp, was collected, crushed and mechanically homogenized into a puree using a Polytrawn T high-speed homogenizer. The moisture content of tomato puree that was obtained was 88-90% on a wet basis.

The tomato puree was subjected to an enzyme-treatment, using 300-units of cellulase/g tomato puree, with stirring at room temperature for 24 hours. Subsequently, the puree was cooked at 70° C. for 20 minutes, and then freeze-dried for 12hr. The moisture content of the product obtained was 9% by weight.

The product was ground into a powder, which was screened through a sieve having a mesh size 0.004-0.5 mm.

The tomato powder was thoroughly mixed with soybean salad oil, using an oil content of 13% w/w. The mixture of powder and oil was stored in the dark in a sealed container at −18° C. until use.

Samples of the mixture of powder and oil were subjected to SFE—CO₂ extraction. The extraction was carried out at a temperature of 45° C. and a pressure of 360 bar for 150 min.

The product obtained from the SFE—CO2 extraction was a lycopene enriched oil product. Analysis of the product showed that the lycopene consisted of 85% trans-isomer and 15% cis-isomer. The colour was dark red. The product was odourless. The amount of lycopene recovered from the tomato powder was more than 55%, which was comparable to exhaustive extraction with hexane-acetone-ethanol solvent (2:1:1v/v/v).

1. A method for the separation of carotenoids from fruits and vegetables, comprising the steps of:
(a) admixing a powder of at least one of said fruits and vegetables with an edible oil;
(b) subjecting the mixture of said powdered fruits and vegetable and edible oil to supercritical —CO₂ fluid extraction;
(c) and separating a mixture of said edible oil and carotenoids.

2. The method of claim 1 in which the carotenoid is lycopene.

3. The method of claim 1 or claim 2 in which the moisture content of the powder is less than 10% by weight.

4. The method of claim 3 in which the moisture content is 6-9% by weight.

5. The method of any one of claims 1-4 in which the powder is formed from skins.

6. The method of any one of claims 1-4 in which the powder is formed from skins and pulp.

7. The method of claim 4 in which the powder has been formed by subjecting fruit and vegetable skins to at least one of mechanical crushing, freezing and thawing, cooking, homogenizing and freeze drying.

8. The method of any one of claims 1-7 in which the edible oil is selected from soybean oil, canola oil, olive oil, corn germ oil, fish oil and peanut oil.

9. The method of any one of claims 1-8 in which the amount of oil is 5-20% by weight of powder.

10. The method of any one of claims 1-9 in which the ratio of powder to oil is in the range of 95:5 to 80:20 by weight.

11. The method of any one of claims 1-10 in which the fruit or vegetable is tomato.

12. The method of claim 11 in which the tomatoes are ripe tomatoes from tomato plants growing in a field.

13. The method of any one of claims 1-12 in which the SFE—CO₂ is operated at a temperature of 45-50° C. and at a pressure of 35-38 MPa for a period of 120-180 minutes.

14. The method any one of claims 1-13 in which the yield of lycopene is at least 55%.

15. The method of any one of Claims. 1-10 in which the fruit or vegetable is a fruit.

16. The method of any one of claims 1-10 in which the fruit or vegetable is a vegetable.
